(19) United States
(12) Patent Application Publication
(10) Pub. No.: US 2006/0061717 A1
(43) Pub. Date: Mar. 23, 2006

(54) Elliptically polarizing plate and liquid crystal display device

(75) Inventor: Mitsuyoshi Ichihashi, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/230,539

(22) Filed: Sep. 21, 2005

(30) Foreign Application Priority Data
Sep. 21, 2004 (JP) 2004-273893

(51) Int. Cl. G02F 1/1335

(52) U.S. Cl. 349/117

(57) ABSTRACT

A novel elliptically polarizing plate is disclosed. The elliptically polarizing plate comprises a polarizing film, two protective films respectively disposed on a surface of the polarizing film, and a retardation film disposed adjacent to at least one of the protective films, wherein an absorption axis of the polarizing film and a slow axis of the retardation film are perpendicular or parallel to each other; the retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and the protective film adjacent to the retardation film comprises a cellulose acylate and has a retardation Rth in the thickness direction of from −30 nm to 30 nm.

### CROSS-REFERENCE TO RELATED APPLICATIONS

This application claims benefit of priority under 35 USC 119 to Japanese Patent Application No. 2004-273893 filed Sep. 21, 2004.

### TECHNICAL FIELD OF THE INVENTION

The present invention relates to an elliptically polarizing plate and to a liquid crystal display device using the same.

### RELATED ART

Liquid crystal display device comprises a liquid crystal cell and polarizing plates. The polarizing plate usually has protective films and a polarizing film, and is obtained typically by dying the polarizing film composed of a polyvinyl alcohol film with iodine, stretching, and being stacked on both surfaces thereof with the protective films. A transmissive liquid crystal display device usually comprises polarizing plates on both sides of the liquid crystal cell, and occasionally comprises one or more optical compensation films. A reflective liquid crystal display device usually comprises a reflector plate, the liquid crystal cell, one or more optical compensation films, and a polarizing plate in this order. The liquid crystal cell comprises liquid-crystalline molecules, two substrates encapsulating the liquid-crystalline molecules, and electrode layers applying voltage to the liquid-crystalline molecules. The liquid crystal cell switches ON and OFF displays depending on variation in orientation state of the liquid-crystalline molecules, and is applicable both to transmission type and reflective type, of which display modes ever proposed include TN (twisted nematic), IPS (in-plane switching), OCB (optically compensatory bend) and VA (vertically aligned), and ECB (electrically controlled birefringence).

Of these LCDs, most widely used for application in need of high definition display is 90° twisted nematic liquid crystal display (referred to as “TN mode”, hereinafter) using nematic liquid crystal molecules having a positive dielectric anisotropy, driven by thin-film transistors. The TN mode has viewing angle characteristics such as ensuring excellent display characteristics in the front view, but as being degraded in the display characteristics in an oblique view, such as causing lowered contrast, or grayscale inversion which is inversion of brightness in a grayscale image, which are strongly desired to be improved.

In recent years, there has been proposed a vertically-aligned nematic liquid crystal display device (referred to as “VA mode”, hereinafter) as a mode of LCD capable of improving the viewing angle characteristics, in which nematic liquid crystal molecules having a negative dielectric anisotropy is used, wherein the liquid crystal molecules are oriented so as to direct the long axes thereof nearly normal to the substrate under no applied voltage, and are driven by thin-film transistors (see Japanese Laid-Open Patent Publication “Tokkai” No. hei 2-176625). The VA mode is not only excellent in the display characteristics in the front view similarly to the TN mode, but can exhibit wider viewing angle characteristics through adoption of a retardation film for viewing angle compensation. The VA mode is successful in obtaining wider viewing angle characteristics by using two negative uniaxial retardation films, having the optical axes normal to the film surface, on the upper and lower sides of a liquid crystal cell, and it is also known that further more wider viewing angle characteristics can be obtained by additionally applying an uniaxial orientation retardation film having an in-plane retardation value of 50 nm and a positive refractive index anisotropy (see SID 97 DIGEST, p. 845-848).

Use of two retardation films (SID 97 DIGEST, p. 845-848), however, results not only in increase in the cost, but also in degradation in the yield ratio due to need of bonding a number of films, wherein use of a plurality of films raises a problem of increase in the thickness, which is disadvantageous for thinning of the device. An adhesive layer used for stacking stretched films may shrink under varied temperature and humidity, and may cause failures such as separation or warping of the films. Disclosed methods of improving these drawbacks include a method of reducing the number of retardation films (Japanese Laid-Open Patent Publication “Tokkai” No. hei 11-95208) and a method of using cholesteric liquid crystal layer (Japanese Laid-Open Patent Publication “Tokkai” No. 2003-15134, ditto “Tokkai” No. hei 11-95208). These methods were, however, still in need of bonding a plurality of films, and were insufficient in terms of thinning and cost reduction. Another problem resided in that light leakage from the polarizing plate in the oblique view in a black state could not completely be suppressed in the visible light region, and this consequently failed in fully improving the viewing angle. And it was also difficult to completely compensate the visible light, obliquely incident on the polarizing plate, over the entire wavelength of visible light thereof in a black state, and, consequently, color shifts depending on the viewing angle. A proposal has been made also on control of wavelength dispersion of retardation of the retardation film so as to reduce the light leakage (Japanese Laid-Open Patent Publication “Tokkai” No. 2002-221622), but this resulted in only an insufficient effect of reducing the light leakage.

### SUMMARY OF THE INVENTION

One object of the present invention is to provide a liquid crystal display device, in particular a VA-mode liquid crystal display device, wherein the liquid crystal cell is correctly compensated optically, having a high contrast and being reduced coloration depending on the viewing angle direction in a black state.

Another object of the present invention is to provide an elliptically polarizing plate capable of optically compensating a liquid crystal cell, in particular a VA mode liquid crystal cell and contributing to an improvement of the contrast and reduction of the coloration depending on the viewing angle direction in a black state.

In one aspect, the present invention provides an elliptically polarizing plate comprising:
a polarizing film,
two protective films respectively disposed on a surface of the polarizing film, and
a retardation film disposed adjacent to at least one of the protective films,
wherein an absorption axis of the polarizing film and a slow axis of the retardation film are perpendicular or parallel to each other;
the retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and
the protective film adjacent to the retardation film comprises a cellulose acylate and has a retardation Rth in the thickness direction of from −30 nm to 30 nm.

The protective film adjacent to the retardation film preferably has a thickness of not more than 50 μm.

The protective film adjacent to the retardation film preferably comprises a cellulose acylate having a degree of acyl substitution of from 2.85 to 3.00 and at least one compound capable of lowering the Re and Rth in an amount of from 0.01 to 30% by weight with respect to a solid weight of the cellulose acylate.

In another aspect, the present invention provides a liquid crystal display device comprising at least:
a first polarizing film,
a first retardation film disposed such that an absorption axis thereof and a slow axis of the first polarizing film are perpendicular or parallel to each other,
a second retardation film,
a liquid crystal cell comprising a pair of substrates and a liquid crystal layer interposed between the pair of substrates, in which liquid crystal molecules are aligned substantially vertically against surfaces of the pair of substrates in a black state, and
a second polarizing film,
wherein the first retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and
the second retardation film has an in-plane retardation Re of from 0 to 30 nm and a retardation Rth in the thickness direction of from 150 nm to 400 nm.

As embodiments of the present invention, the liquid crystal display device wherein the first polarizing film, the first retardation film, the second retardation film, and the liquid crystal cell are disposed in this order; and the liquid crystal display device wherein the first polarizing film, the first retardation film, the liquid crystal cell, and the second retardation film are disposed in this order; are provided.

In the liquid crystal display device of the present invention, at least one of the first retardation film and the second retardation film may be an optically anisotropic film comprising liquid crystalline molecules fixed in an alignment state.

The liquid crystal display device of the present invention may further comprise a pair of protective films disposed so as to interpose the first polarizing film therebetween. And it is preferred that the protective film disposed nearer to the liquid crystal cell preferably has a retardation Rth in the thickness direction of from −30 nm to 30 nm. It is also preferred that the protective film disposed nearer to the liquid crystal cell is a cellulose acylate film comprising a cellulose acylate having a degree of acyl substitution of from 2.85 to 3.00 and at least one compound capable of lowering the Re and Rth in an amount of from 0.01 to 30% by weight with respect to a solid weight of the cellulose acylate. It is also preferred that the protective film disposed nearer to the liquid crystal cell has a thickness of not more than 50 μm.

### BRIEF DESCRIPTION OF THE DRAWINGS

FIG. 1 is a schematic view with respect to a construction example for explaining an effect of the invention.

FIG. 2 is an outline view to show one embodiment of a liquid crystal display device of the invention.

FIG. 3 is an outline view to show another embodiment of a liquid crystal display device of the invention.

In the drawings, reference numerals and signs have the following meanings.
1a, 1b, 7a, 7b: Protective film for polarizing film
2a, 8a: Polarizing film
2b, 8b: Polarizing absorption axis of polarizing film
3a: First retardation film
3b: Slow axis of first retardation film
4a, 4b: Cell substrate
5: Liquid crystal molecule
6: Second retardation film
11, 12 Polarizing plate
13 Liquid crystal cell
14 First retardation film
15 Second retardation film

### DETAILED DESCRIPTION OF THE INVENTION

Hereafter, the present invention will be explained in detail. In the specification, ranges indicated with “to” mean ranges including the numerical values before and after “to” as the minimum and maximum values.

In the specification, Re(λ) and Rth(λ) respectively mean an in-plane retardation and a retardation in a thickness-direction at wavelength λ. The Re(λ) is measured by using KOBRA-21ADH (manufactured by Oji Scientific Instruments) for an incoming light of a wavelength λnm in a direction normal to a film-surface. The Rth λ) is calculated by using KOBRA-21ADH based on three retardation values; first one of which is the Re(λ) obtained above, second one of which is a retardation which is measured for an incoming light of a wavelength λnm in a direction rotated by +40° with respect to the normal direction of the film around an in-plane slow axis, which is decided by KOBRA 21ADH, as an a tilt axis (a rotation axis), and third one of which is a retardation which is measured for an incoming light of a wavelength λnm in a direction rotated by −40° with respect to the normal direction of the film around an in-plane slow axis as an a inclining axis (a rotation axis); a hypothetical mean refractive index and an entered thickness value of the film. The wavelength λ generally falls within the range from 450 to 750 nm. According to the present invention, the wavelength λ is 589 nm. The mean refractive indexes of various materials are described in published documents such as “POLYMER HANDBOOK” (JOHN WILEY&SONS, INC) and catalogs. If the values are unknown, the values may be measured with an abbe refractometer or the like. The mean refractive indexes of major optical films are exemplified below:
cellulose acylate (1.48), cyclo-olefin polymer (1.52), polycarbonate (1.59), polymethyl methacrylate (1.49), polystyrene (1.59).

When the hypothetical mean refractive index and a thickness value are put into KOBRA 21ADH, nx, ny and nz are calculated. And Nz, which is equal to (nx−nz)/(nx−ny), is calculated based on the calculated nx, ny and nz.

In the specification, the term of “A is parallel to B” or the term of “A is orthogonal to B” means that the angle between A and B falls within a range of an exact angle ±5°. The angle desirably falls within a range of an exact angle ±4°, and more desirably within a range of an exact angle ±3°. The term of “A is perpendicular to B” means that the angle between A and B falls within a range of an exact angle ±5°. The angle desirably falls within a range of an exact angle ±4°, and more desirably within a range of an exact angle ±3°. The term of “visible light wavelength” means a wavelength from 380 nm to 780 nm. The term of “slow axis” means a direction giving a maximum refractive index. As long as written specifically, refractive indexes are measured at 550 nm.

In the specification, the terms of “polarizing plate” means not only polarizing plates having a proper size to be employed in a liquid-crystal but also long polarizing plates before being cut. And in the specification, the terms of “polarizing film” is distinct from the term “polarizing plate”, and the term of “polarizing plate” is used for any laminated body comprising a “polarizing film” and at least one protective film thereon.

Embodiments of the invention will be hereunder described in detail with reference to the accompanying drawings.

First, an effect of the invention will be hereunder described. A liquid crystal display device employing a VA mode comprises a liquid crystal cell comprising a liquid crystal layer in which liquid crystal molecules are aligned vertically against the surface of a substrate when no voltage is applied, namely in a black state, and two polarizing plates which are disposed sandwiching the liquid crystal cell so that the transmission axes thereof are perpendicular to each other. When no voltage is applied, the normal incident light from the incoming-side polarizing plate passes through the vertically aligned liquid crystal layer of the liquid crystal cell while keeping the linear polarization state and, thus, is completely blocked by the outgoing-side polarizing plate. As a result, it becomes possible to display images with high contrast. However, the oblique incident light from the incoming-side polarizing plate passes through the vertically aligned liquid crystal layer of the liquid crystal cell and is influenced by retardation of the oblique direction, whereby its polarization state is changed. In addition, the apparent disposition of the two transmission axes of the polarizing plates is shifted from the perpendicular disposition. Due to these two factors, the oblique incident light is not completely blocked by the outgoing-side polarizing plate, and light leakage is generated in a black state, resulting in a lowering of the contrast.

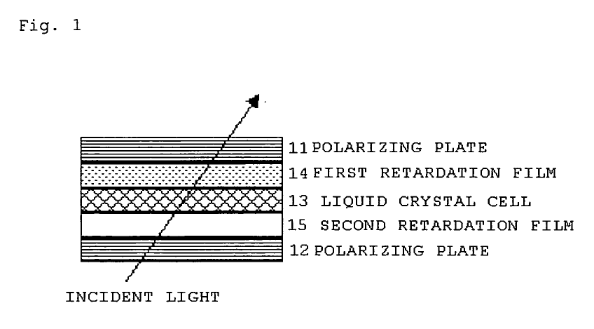

FIG. 1 shows a schematic view with respect to a construction example for explaining an effect of the invention. The construction of FIG. 1 is concerned with a construction in which a first retardation film 14 and a second retardation film 15 are disposed between a liquid crystal cell 13 and a polarizing plate 11. The liquid crystal cell 13 has a pair of substrates and a liquid crystal layer interposed between the substrates, and liquid crystal molecules in the liquid crystal layer are aligned substantially vertically against the surfaces of the pair of substrates in a black state. The first retardation film 14 has an Nz value, as defined according to (Nz=Rth/Re+0.5) by using an in-plane retardation Re and a retardation Rth in the thickness direction, of from 0.3 to 0.7 and that an in-plane retardation Re of from 150 to 400 nm. The second retardation film 15 has an in-plane retardation of from 0 to 30 nm and a retardation Rth in the thickness direction of from 150 nm to 400 nm.

According to the embodiment, shown in FIG. 1, of the present invention, the oblique incident light passes through the second retardation film 5 before passing through the liquid crystal 13, and thereby keeps the polarization state after passing through the liquid crystal cell 13. Subsequently, passing through the first retardation film 14, the oblique incident light is influenced by retardation of the oblique direction, whereby its polarization state can be fit to an apparent absorption axis of the outgoing-side polarizing plate. In the embodiment of the present invention, the second retardation film 15 and the liquid crystal cell 13 are combined in a manner such that the wavelength dependency of the retardation can be lowered, and the first retardation film 14 gives a small wavelength dependency effect to the incident polarized light keeping the initial polarized state. Accordingly, as compared to conventional liquid crystal display devices, not only the viewing angle contrast in a black state is remarkably improved, but also coloration depending on the viewing angle direction in a black state is remarkably reduced. Incidentally, while the effect of the invention has been explained with reference to FIG. 1, the effect of the invention can be similarly explained even with respect to a construction in which the disposition of the liquid crystal cell 13 and the second retardation film 15 is replaced with each other. The scope of the invention is not limited by the display mode of the liquid crystal layer, but the invention can also be applied to liquid crystal display devices having a liquid crystal layer of any display mode such as a VA mode, an IPS mode, an ECB mode, a TN mode, and an OCB mode.

According to the present invention, it is possible to compensate the viewing angle of a liquid crystal cell of a VA mode in a black state over substantially all wavelengths. As a result, according to the liquid crystal display device of the invention, oblique light leakage in a black state is reduced, and the viewing angle contrast is remarkably improved. Also, according to the liquid crystal display device of the invention, since oblique light leakage in a black state can be reduced over a substantially entire wavelength region of visible light, color shift depending on the viewing angle in a black state is largely reduced.

The construction of the liquid crystal display device of the invention, preferred optical characteristics of a variety of members which can be used in the liquid crystal display device, materials which are used for the members, production processes thereof, and the like will be hereunder described in detail.

[Liquid Crystal Cell of VA Mode]

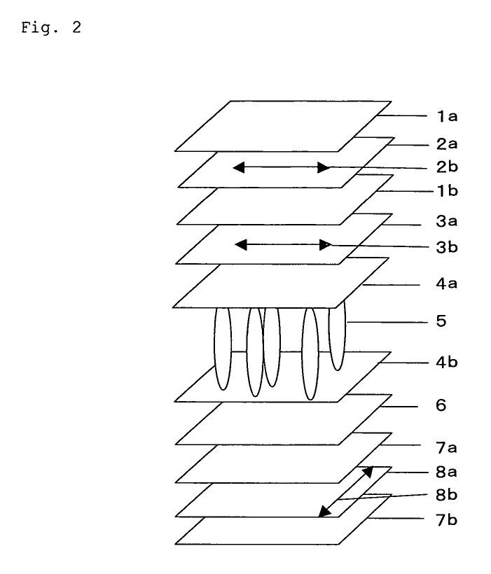

A mode for carrying out the invention, in which the invention is applied to a liquid crystal display device of a VA mode, will be described below with reference to FIG. 2. A liquid crystal display device as shown in FIG. 2 comprises an upper polarizing film 2a and a lower polarizing film 8a disposed so as to interpose a liquid crystal cell (4a, 5, 4b) therebetween. A first retardation film 3a is positioned between the upper polarizing film and the liquid crystal cell, and a second retardation film 6 is positioned between the lower polarizing film 8a and the liquid crystal cell. Furthermore, it is possible to make each of the first retardation film 3a and a transparent protective film 1b have the both functions by one sheet. Similarly, it is also possible to make each of the second retardation film 6 and a transparent protective film 7a have the both functions by one sheet.

The liquid crystal cell comprises an upper substrate 4a and a lower substrate 4b and a liquid crystal layer comprising liquid crystal molecules 5 interposed therebetween. On the surface of each of the substrates 4a and 4b coming into contact with the liquid crystal molecules 5 (this surface will be hereinafter sometimes referred to as “internal surface”), an alignment film (not shown in the drawing) is formed, and in the state that no voltage is applied or a low voltage is applied, the alignment of the liquid crystal molecules 5 is controlled in the vertical direction. Furthermore, a transparent electrode (not shown in the drawing) capable of applying a voltage to a liquid crystal layer comprising the liquid crystal molecules 5 is formed on the internal surface of each of the substrates 4a and 4b. In the invention, the product Δn·d of a thickness d (μm) and a refractive index anisotropy Δn of the liquid crystal layer is preferably from 0.1 to 1.0 μm. In addition, an optimum value of Δn·d is more preferably from 0.2 to 1.0 μm, and further preferably from 0.2 to 0.5 μm. Within this range, the luminance in a white state is high and the luminance in a black state is low, and therefore, a bright display device with high contrast is obtained. Though a liquid crystal material to be used is not particularly limited, in an embodiment wherein an electric field is applied between the upper and lower substrates, a liquid crystal material having negative dielectric anisotropy is used such that the liquid crystal molecules 5 respond vertically in the electric field direction. Moreover, in the case where an electrode is formed in either one of the substrates 4a and 4b and an electric field is applied in the transverse direction parallel to the substrate surface, a liquid crystal material having positive dielectric anisotropy can be used.

For example, in the case where the liquid crystal cell is a liquid crystal cell employing a VA mode, a nematic liquid crystal material having negative dielectric anisotropy and having a Δn of 0.0813, and a Δε of about −4.6 can be used between the upper and lower substrates 4a and 4b. Though the thickness d of the liquid crystal layer is not particularly limited, in the case of using a liquid crystal having characteristics falling within the foregoing range, it can be set up at about 3.5 μm. Since the brightness in a white state is changed by the value of the product Δn·d of the thickness d and the refractive index anisotropy Δn, in order to obtain the maximum brightness, it is preferred to set up the Δn·d such that it is in the range of from 0.2 to 0.5 μm.

In the liquid crystal display device employing a VA mode, though a chiral material which is generally used in a liquid crystal display device employing a TN mode is scarcely used because it deteriorates dynamic responsive characteristics, it may possibly be added for the purpose of reducing alignment failure. Also, the case of realizing a multi-domain structure is advantageous for adjusting the alignment of a liquid crystal molecule in a boundary region between the respective domains. The “multi-domain structure” as referred to herein means a structure in which one pixel of a liquid crystal display device is divided into plural regions. For example, in the VA mode, since the liquid crystal molecules 5 are tilted in a white state, the birefringence of the liquid crystal molecules 5 when viewed from one oblique direction differs from that when viewed from the opposite oblique direction, and differences in luminance and color tone are generated. However, the multi-domain structure is preferable because luminance and view field characteristics of color tone are improved. Concretely, by constructing pixels in two or more (preferably 4 or 8) regions where the initial alignment state of the liquid crystal molecules is different from each other and averaging them, it is possible to reduce the deviation of the luminance or the color tone depending on the viewing angle. The same effect can also be obtained even by constructing respective pixels by two or more regions in which the alignment direction of the liquid crystal molecules varies continuously in the state that a voltage is applied.

In order to form plural regions in which the alignment direction of the liquid crystal molecule 5 is different within one pixel, for example, methods such as a method for providing slits on the electrode, a method for providing protrusions, a method for varying the electric field direction, and a method for grading the electric field density can be utilized. In order to obtain an equal viewing angle character in the omni-direction, the number of divisions may be increased. However, by dividing the viewing angle into four or eight or more sections, a substantially equal viewing angle character is obtained. In particular, since it is possible to set up an absorption axis of the polarizing plate at an arbitrary angle at the time of dividing it into eight sections, such is preferable. In the region boundary between the respective domains, the liquid crystal molecules 5 tend to hardly respond. In the normally black mode such as a VA mode, since a black state is kept, the luminance is lowered. Then, by adding a chiral agent to the liquid crystal material, it becomes possible to make the boundary region between the domains small. On the other hand, in the normally white mode, since a white state is kept, the frontal contrast is lowered. Then, it is recommended to provide a shielding layer such as a black matrix for covering that region.

Absorption axes 2b and 8b of the polarizing films 2a and 8a are disposed such that they are substantially perpendicular to each other. The polarizing films 2a and 8a, and the first retardation films 3a and the second retardation 6 disposed between the liquid crystal cells are each selected from birefringent polymer films or laminates comprising a transparent support and an optically anisotropic layer formed of a liquid crystal composition formed on the transparent support. It is preferable that an in-plane slow axis 3b of the first retardation film 3a is disposed substantially parallel or perpendicular to the absorption axis 2b of the polarizing film 2a disposed nearer to the first retardation film 3a. On the other hand, in the case where an in-plane slow axis (not shown in the drawing) of the second retardation film 6 has an Re value exceeding 0 so that the slow axis can be confirmed, it is preferable that the in-plane slow axis of the second retardation film 6 is disposed substantially parallel or perpendicular to the absorption axis 8b of the polarizing film 8a disposed nearer to the second retardation film 6. When the members disposed in such disposition, the optical compensation film 3a or 6 can give retardation to the normal incident light, thereby causing no light leakage, and can give thoroughly the effect of the invention to the oblique incident light.

In the liquid crystal display device as shown in FIG. 2, the protective film 1b or the protective film 7a may be absent. However, in the case where the protective film 1b is not provided, it is necessary that the first retardation film 3a not only has specific optical characteristics as described later but also functions to protect the polarizing film 2a. In the case where the protective film 1b is disposed, the retardation Rth of the protective film in the thickness direction is preferably from −30 nm to 30 nm, and more preferably from −10 nm to 10 nm. Also, in the case where the protective film 7a is disposed, the retardation Rth of the protective film in the thickness direction preferably falls within the range of ±30 nm, and more preferably the range of ±10 nm centering on a value of the difference between Rth of the liquid crystal cell and Rth of the second retardation film 6 in a black state. Also, it is preferable that the thickness of each of the protective film 1b and the protective film 7a is thin, and concretely, the thickness is preferably not more than 60 μm and more preferably not more than 50 μm.

In the embodiment as shown in FIG. 2, the first retardation film 3a may be disposed between the liquid crystal cell and the polarizing film 2a in the viewing side or may be disposed between the liquid crystal cell and the polarizing film 8a in the back face side on the basis of the position of the liquid crystal cell. In all of these embodiments, the liquid crystal cell is disposed such that it is interposed between the second retardation film 6 and the first retardation film 3a.

In the non-drive state that a drive voltage is not applied to the respective transparent electrodes (not shown in the drawing) of the liquid crystal cell substrates 4a and 4b, the liquid crystal molecules 5 in the liquid crystal layer are aligned substantially vertically against the planes of the substrates 4a and 4b. As a result, the polarization state of the transmitted light does not substantially change. Since the absorption axes 2b and 8b are perpendicular to each other, the incident light from the lower side (for example, the back electrode) is polarized by the polarizing film 8a, passes through the liquid crystal cell while keeping the polarization state, and is blocked by the polarizing film 2a. That is, in the liquid crystal display device as shown in FIG. 2, an ideal black state is obtained in the non-drive state. On the other hand, in the drive state that a drive voltage is applied to the transparent electrodes (not shown in the drawing), the liquid crystal molecules 5 are tilted to the parallel direction to the planes of the substrates 4a and 4b, and the polarization state of the transmitted light is changed by the tilted alignment of the liquid crystal molecules 5. Accordingly, the incident light from the lower side (for example, the back electrode) is polarized by the polarizing film 8a, passes through the liquid crystal cell, whereby its polarization state is changed, and then passes through the polarizing film 2a. That is, in the drive state that a voltage is applied, a white state is obtained.

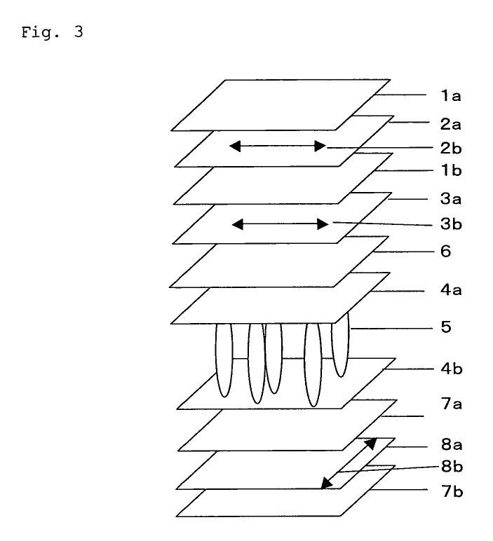

Another embodiment of the invention is shown in FIG. 3. In FIG. 3, with respect to the same members as in FIG. 2, the same symbols are given, and detail explanations thereof are not provided. In a liquid crystal display device as shown in FIG. 3, the position of the second retardation film 6 is replaced, and the second retardation film 6 is disposed at the position between the first retardation film 3 aand the liquid crystal cell. The relationship between the disposition of optical axes of the two sheets of polarizing films and the disposition of optical axes of the first retardation film 3a and the second retardation film 6 is the same as in the foregoing FIG. 2.

Likewise the foregoing case, in the liquid crystal display device as shown in FIG. 3, the protective film 1b or the protective film 7a may be absent. However, in the case where the protective film 1b is not provided, it is necessary that the first retardation film 3a not only has specific optical characteristics as described later but also functions to protect the polarizing film 2a. In the case where the protective film 1b is disposed, the retardation Rth of the protective film in the thickness direction is preferably from −30 nm to 30 nm, and more preferably from −10 nm to 10 nm. Also, in the case where the protective film 7a is disposed, the retardation Rth of the protective film in the thickness direction preferably falls within the range of ±30 nm, and more preferably the range of +10 nm centering on a value of the difference between Rth of the liquid crystal cell and Rth of the second retardation film 6 in a black state. Also, it is preferable that the thickness of each of the protective film 1b and the protective film 7a is thin, and concretely, the thickness is preferably not more than 60 μm and more preferably not more than 50 μm.

In the embodiment as shown in FIG. 3, the first retardation film 3a and the second retardation film 6 may be disposed between the liquid crystal cell and the polarizing film 2a in the viewing side or may be disposed between the liquid crystal cell and the polarizing film 8a in the back face side on the basis of the position of the liquid crystal cell. In all of these embodiments, the second retardation film 6 is disposed in the nearer side to the liquid crystal cell.

The liquid crystal display device of the invention is not limited to the constructions as shown in FIGS. 1 to 3 but may contain other members. For example, a color filter may be disposed between the liquid crystal cell and the polarizing film. Also, when used as a transmission type, a cold-cathode or hot-cathode fluorescent tube or a backlight using, as a light source, a light emitting diode, a field emission element or an electroluminescent element can be disposed on the back face. Also, a reflection type polarizing plate or a diffusion plate, or a prism sheet or a light guide plate can be disposed, too between the liquid crystal layer and the backlight. Also, as described previously, the liquid crystal display device of the invention may be of a reflection type. In such case, only one sheet of a polarizing plate may be disposed in the viewing side, and a reflection film is disposed on the back face of the liquid crystal cell or on the internal surface of the lower substrate of the liquid crystal cell. As a matter of course, it is also possible to provide a frontlight using the foregoing light source in the viewing side of the liquid crystal cell.

The type of the liquid crystal display device of the invention is not particularly limited, and examples thereof include an image direct-view type, an image projection type, and a light modulation type. The invention is efficient for an active matrix liquid crystal display device using a three-terminal semiconductor element or two-terminal semiconductor elements such as TFT and MIM. As a matter of course, the invention is also efficient for a passive matrix liquid crystal display device typified by STN type as called “time sharing drive”.

Next, optical characteristics, various materials, processes, and the like of a variety of members which can be used in the liquid crystal display device of the invention, including the first retardation film, the second retardation film, the elliptically polarizing plate, and the like will be hereunder described in more detail.

[First Retardation Film]

In the invention, the first retardation film contributes to improvement of the viewing angle of a liquid crystal display device, in particular, a liquid crystal display device employing a VA mode, and reduction of color drift depending on the viewing angle. The first retardation film may be disposed between the polarizing plate in the observer side and the liquid crystal cell, may be disposed between the polarizing plate in the back face side and the liquid crystal cell, or may be disposed in the both. For example, the first retardation film can be incorporated as an independent member into the liquid crystal display device. The first retardation film can also be incorporated as one member of the polarizing plate into the liquid crystal display device by imparting the foregoing optical characteristics to the protective film for protecting the polarizing film, thereby making it function as an optical compensation film.

In the invention, being disposed such that the slow axis thereof and the absorption axis of the polarizing film are perpendicular to each other, the first retardation film can contribute to decreasing light leakage due to shifting of the polarizing absorption axis for the oblique incident light from the perpendicular state with less coloration. The first retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm. The Nz value is preferably from 0.4 to 0.60, and more preferably from 0.45 to 0.55 in view of the compensating function. On the other hand, the in-plane retardation Re is preferably from 200 nm to 350 nm, and more preferably from 250 nm to 300 nm in view of the compensating function. Though the thickness d of the retardation film is not particularly limited, it is usually from about 40 to 100 μm, and preferably from 50 to 70 μm.

In the invention, the first retardation film is not particularly limited with respect to materials and form thereof so far as it has the foregoing optical characteristics. For example, retardation films formed of a birefringent polymer film, films as prepared by applying a polymer composition to a surface of a transparent support and then heating, and retardation films comprising a retardation layer formed by applying or transferring a composition comprising a low molecular or high molecular liquid crystalline compound to a transparent support can be used. A laminate of these films can also be used.

As the birefringent polymer film, ones having excellent controlling properties of the birefringence characteristic, transparency and heat resistance and ones having low optical elasticity are preferable. In this case, the polymer material to be used is not particularly limited so far as it can achieve uniform biaxial alignment. Ones which can be subjected to film formation by the solvent casting method or extrusion molding system are preferable, and examples thereof include norbornene based polymers, polycarbonate based polymers, polyallylate based polymers, polyester based polymers, aromatic polymers such as polysulfone, polyolefins such as polypropylene, cellulose acylates, and mixed polymers of two or three or more kinds of these polymers.

The biaxial alignment of the film can be obtained by stretching a film which is produced by an appropriate system such as an extrusion molding system and a cast film formation system by, for example, a longitudinal stretching system by rolls, a transversal stretching system by a tenter, or a biaxial stretching system. Also, it is obtained by controlling a refractive index by a method for uniaxially or biaxially stretching a film in the plane direction and stretching the resulting film in the thickness direction or other methods. Also, it is obtained by a method for adhering a polymer film to a thermally shrinkable film and stretching and/or shrinking the polymer film under a shrinkage force by heating to achieve alignment or other methods (see, for example, Japanese Laid-Open Patent Publication “Tokkai” Nos. hei 5-157911, hei 11-125716, and 2001-13324). In the foregoing longitudinal stretching system by rolls, an appropriate heating method such as a method of using heat rolls, a method of heating the atmosphere, and a combination thereof can be employed. Furthermore, in the biaxial stretching system by a tenter, an appropriate method such as a simultaneous biaxial stretching method by an entire tenter system and a sequential biaxially stretching method by the roll tenter method can be employed. Furthermore, polymer films which are less in alignment unevenness or retardation unevenness are preferable. Though the thickness thereof can be properly determined by the retardation and the like, in general, it is preferably from 1 to 300 μm, more preferably from 10 to 200 μm, and further preferably from 20 to 150 μm in view of realizing a thin thickness.

Examples of the liquid crystalline polymer include a main chain type and side chain type polymers in which a conjugated linear atomic group (mesogen) capable of imparting liquid crystal alignment properties is introduced into the main chain or side chain. Specific examples of such main chain-type liquid crystalline polymer include polymers having a structure in which a mesogen groups are bound each other via a spacer segment capable of imparting flexibility, such as polyester based liquid crystalline polymers with nematic alignment properties, discotic polymers, and cholesteric polymers. Specific examples of such side chain-type liquid crystalline polymer include polymers containing, as a main chain skeleton, a polysiloxane, a polyacrylate, a polymethacrylate or a polymalonate and, as a side chain, a mesogen segment composed of para-substituted cyclic units, capable of imparting nematic alignment property, bonding each other via a spacer segment composed of a conjugated atomic group. For aligning such liquid crystalline polymers, alignment films may be used. Examples of such alignment films include alignment films obtained by rubbing the surface of a thin film of a polyimide, polyvinyl alcohol, etc. as formed on a glass plate and alignment films obtained by oblique vapor deposition with silicon oxide, etc. The coating fluid comprising the liquid crystalline polymer may be allied to a surface of such alignment film and thermally treating it to align the liquid crystal polymer molecules. Of these, alignment films resulting from oblique alignment are preferable.

In laminating the first retardation film and the polarizing film or the protective film of the polarizing film, in view of sticking precision of the axes, it is preferable that the both films are continuously stuck such that the absorption axis of the polarizing film and the slow axis of the first retardation film are disposed perpendicular or parallel to each other.

[Second Retardation Film]

In the invention, it is preferable that in-plane refractive indexes nx and ny of the second retardation film are substantially equal to each other. A difference therebetween is preferably not more than 0.05, more preferably not more than 0.02, and further preferably not more than 0.01. Also, in the case where the second retardation film also serves as a protective film (the case where the protective film 7a of the polarizing film 8 in FIGS. 2 and 3 is absent), an in-plane retardation Re is preferably not more than 30 nm, more preferably not more than 20 nm, and further preferably not more than 10 nm. Also, a retardation Rth of the second retardation film in the thickness direction is from 150 nm to 400 nm, more preferably from 180 nm to 350 nm, and further preferably from 240 nm to 320 nm. In the case where the protective film 7a is disposed, the retardation Rth of the second retardation film preferably falls within the range of ±50 nm, more preferably the range of ±30 nm, and most preferably the range of ±10 nm centering on a value of the difference between Rth of the liquid crystal cell and Rth of the protective film in the thickness direction in a black state.

In this embodiment, though the disposition of the slow axis of the second retardation film is not particularly limited, in the case where the Re of the second retardation film exceeds 5 nm, it is preferable that the second retardation film is disposed that the slow axis thereof is perpendicular or parallel to the transmission axis of the polymerizing film to be disposed nearer to the second retardation film.

The second retardation film is not particularly limited with respect to materials thereof so far as it has the foregoing optical characteristics. For example, retardation films formed of a birefringent polymer film, films as prepared by applying a polymer composition to a surface of a transparent support and then heating, and retardation films comprising a retardation layer formed by applying or transferring a composition comprising a low molecular or high molecular liquid crystalline compound to a transparent support can be used. A laminate of these films can also be used.

The retardation film formed of a birefringent polymer film having the foregoing optical characteristics can also be easily formed by uniaxially or biaxially stretching a polymer film (see, for example, Japanese Laid-Open Patent Publication “Tokkai” Nos. 2002-139621 and 2002-146045). Also, cellulose acylates which reveal the optical characteristics only by casting without performing stretching can be suitably used. As such cellulose acylates, ones described in Japanese Laid-Open Patent Publication “Tokkai” Nos. 2000-275434, 2001-166144, 2002-161144, and 2002-90541 can be used. As the material of the polymer film, synthetic polymers (for example, polycarbonate, polysulfone, polyethersulfone, polyacrylate, polymethacrylate, norbornene reins, and cellulose acylates) are generally used.

The retardation layer formed of a composition comprising a liquid crystalline compound having the foregoing optical characteristics can be formed by applying a cholesteric liquid crystalline composition comprising a rod-like liquid crystalline compound having a chiral structural unit to a surface of a support, a temporary support or the like, and aligning rod-like molecules with a spiral axis thereof substantially vertically to the surface, and fixing the molecules in the alignment state. In the case where the retardation layer is formed on a temporary support, the resulting retardation layer can be transferred onto a support. Also, a retardation layer prepared by homogenously aligning discotic liquid crystalline molecules with negative birefringence (a director is disposed vertical to the substrate), and fixing the molecules in the alignment state; and a retardation layer prepared by casting a polyimide material on a substrate, and followed by immobilization can be similarly used. In addition, a second retardation film exhibiting the foregoing optical characteristics can be produced by not only one sheet of a retardation layer but also a laminate of plural retardation layers. The second retardation film may also be constructed so as to meet the foregoing optical characteristics by the whole of a laminate of the support and the retardation layer.

The second retardation film comprising a retardation layer formed of a composition comprising a discotic liquid crystalline compound can be formed by applying a coating fluid comprising a discotic liquid crystalline compound and, if necessary, an additive such as a polymerizable initiator, an air interfacial homogenously aligning agent (see, for example, Japanese Patent Application No. 2003-388308) or the like to a surface of a homogenous alignment film formed on a support. As the alignment film capable of aligning discotic liquid crystal molecules homogenously, alignment films formed of a polymer material, comprising an organic acid or salt thereof in a solid content of less than 0.1% by weight, such as polyvinyl alcohol, polyimides, polyamides, and polyacrylic resins can be used. After forming the alignment film, rubbing may or may not be carried out.

Besides, with respect to examples of the discotic liquid crystalline compound which can be used, examples of a solvent to be used for the preparation of a coating fluid, examples of a coating method, other materials such as polymerizable initiators and polymerizable monomers, and the support which is used for the formation of the retardation film, the description of Japanese Patent Application No. 2004-37835 can be similarly applied.

[Polarizing Plate]

In the invention, a polarizing plate comprising a polarizing film and a pair of protective films interposing the polarizing film therebetween can be used. For example, a polarizing plate obtained by dyeing a polarizing film made of a polyvinyl alcohol film, etc. with iodine, stretching the resulting polarizing film and laminating a protective film on the both surfaces thereof can be used. The subject polarizing plate is disposed outside a liquid crystal cell. It is preferable that a pair of polarizing plates comprising a polarizing film and a pair of protective films interposing the polarizing film therebetween are disposed while interposing a liquid crystal cell therebetween.

A polarizing film is not particularly limited, and various kinds can be used. Examples of the polarizing film include ones obtained by adsorbing a dichroic substance (for example, iodine and dichroic dyes) on a hydrophilic polymer film (for example, a polyvinyl alcohol based film, a partially formalized polyvinyl alcohol based film, and an ethylene/vinyl acetate copolymer based partially saponified film) and polyene based alignment films (for example, a dehydration product of polyvinyl alcohol and a dehydrochlorination product of polyvinyl chloride). Of these, polarizing films comprising a polyvinyl alcohol based film and a dichroic substance such as iodine are suitable. Though the thickness of such a polarizing film is not particularly limited, it is in general from about 5 to 80 μm.

A polarizing film prepared by dyeing a polyvinyl alcohol based film with iodine and uniaxially stretching it can be prepared by, for example, dyeing a polyvinyl alcohol based film by dipping in an aqueous solution of iodine and then stretching the film 3 to 7 times the original length. If desired, the film can be dipped in an aqueous solution of potassium iodide which may contain boric acid, zinc sulfate, zinc chloride, etc. In addition, if desired, the polyvinyl alcohol based film may be washed with water by dipping in water prior to dyeing. By washing the polyvinyl alcohol based film with water, not only stains or an anti-blocking agent on the surface of the polyvinyl alcohol based film can be washed away, but also an effect for preventing heterogeneity such as dyeing unevenness is brought by swelling the polyvinyl alcohol based film. Stretching may be performed after dying with iodine or may be performed while dyeing. Also, after stretching, dyeing with iodine may be performed. Stretching can also be performed in an aqueous solution of boric acid, potassium iodide, etc. or in a water bath.

It is preferable that the polarizing plate comprising a transparent protective film and a polarizing film related to the invention has a performance comparable to or more than commercially available super high contrast products (for example, HLC2-5618, manufactured by Sanritz Corporation) with respect to the optical nature and durability (short-term or long-term storage properties). Concretely, a visible light transmittance is 42.5% or more; a degree of polarization [{(Tₚ−T_{c})/(Tₚ+T_{c})}^{1/2}] is 0.9995 or more (wherein Tₚ represents a parallel transmittance, and T_{c} represents a cross transmittance); when allowed to stand for 500 hours in an atmosphere at 60° C. and at a humidity of 90% RH and for 500 hours in a dry atmosphere at 80° C., a rate of change in the light transmittance before and after allowing to standing is preferably not more than 3%, and more preferably not more than 1% on the basis of an absolute value; and a rate of change in the degree of polarization is preferably not more than 1%, and more preferably not more than 0.1% on the basis of an absolute value.

[Protective Film for Polarizing Film]

As the protective film for polarizing film, one having no absorption in a visible light region, having a light transmittance of 80% or more, and having a low retardation on the basis of birefringent properties is preferable. In an embodiment wherein the absorption axis of the polarizing film and the alignment axis of the transparent protective film are not parallel to each other, in particular, when the retardation value of the transparent protective film is a certain value or more, since the polarizing axis of the polarizing film and the alignment axis (slow axis) of the transparent protective film are obliquely shifted, linear polarization changes to elliptical polarization, and therefore, such is not preferable. Accordingly, the in-plane Re of the transparent protective film is preferably from 0 to 30 nm, more preferably from 0 to 15 nm, and most preferably from 0 to 5 nm. Also, the retardation Rth of the protective film for polarizing film disposed nearer to the first retardation film in the thickness direction is preferably from −30 nm to 30 nm, more preferably from −20 nm to 20 nm, and much more preferably from −10 nm to 10 nm in view of an effect for compensating the coloration.

Furthermore, in the case where the transparent protective film 7a to be disposed nearer to the liquid crystal cell is disposed, the retardation Rth of the subject protective film (the transparent protective films 1b and 7a in FIGS. 2 and 3) in the thickness direction preferably falls within the range of ±30 nm, and more preferably the range of ±10 nm centering on a value of the difference between Rth of the liquid crystal cell and Rth of the second retardation film 6 in a black state. In the case where a laminate comprising a support having thereon an optically anisotropic layer made of a liquid crystalline compound is utilized as the first or second retardation film, the protective film may also serves as a support of the optically anisotropic layer.

Furthermore, the thickness of the protective film, especially the thickness of the protective film to be disposed in the liquid crystal cell side is preferably not more than 50 μm, more preferably not more than 40 μm, and further preferably not more than 30 μm from the viewpoint that the Rth be made low. However, in the case where the protective film is composed of plural layers for the purpose of meeting the foregoing optical characteristics, a preferred range of the thickness is not limited to this range.

Though any film can be suitably used for the protective film so far as it is satisfactory with the foregoing characteristics, it is more preferable from the viewpoint of durability of the polarizing film that the protective film contains a cellulose acylate or norbornene based film. Furthermore, from the viewpoint of a wavelength dispersing characteristic of the refractive index anisotropy, cellulose acylates in which the refractive index anisotropy is substantially constant regardless of the wavelength of light or the refractive index anisotropy in the short wavelength side is low are the most preferable.

Examples of the norbornene based polymer materials include polymers of a monomer containing, as the major component, a norbornene based monomer (for example, norbornene and derivatives thereof, tetracyclododecene and derivatives thereof, dicyclopentadiene and derivatives thereof, and methanotetrahydrofluorenone and derivatives thereof) such as ring opening polymers of a norbornene based monomer, ring opening copolymers of a norbornene based monomer and other monomer which is ring opening copolymerizable therewith, addition polymers of a norbornene based monomer, addition copolymers of a norbornene based monomer and other monomer which is ring opening copolymerizable therewith, and hydrogenation products thereof. Of these, ring opening polymer hydrides of a norbornene based monomer are more preferable from the viewpoints of heat resistance, mechanical strength and so on. The molecular weight of the norbornene based polymer, monocyclic olefin polymer or cyclic conjugated diene polymer is properly chosen depending upon the intended object for use. When a weight average molecular weight, as reduced into polyisoprene or polystyrene by the gel permeation chromatography with respect to a cyclohexane solution thereof (a toluene solution thereof when, however, the polymer resin is not dissolved), is usually in the range of from 5,000, to 500,000, preferably from 8,000 to 200,000, and more preferably from 10,000 to 100,000, the film is highly balanced between mechanical strength and molding processability and therefore, is suitable.

In the cellulose acylates, the acyl group may be an aliphatic group or an aromatic group and is not particularly limited. Examples of the cellulose acylates include alkylcarbonyl esters, alkenylcarbonyl esters, aromatic carbonyl esters, and aromatic alkylcarbonyl esters of cellulose. These cellulose esters may further have a substituted group, and ester groups having not more than 22 carbon atoms in total are preferable. Preferred examples of these cellulose acylates include ones in which the ester moiety thereof has not more than 22 carbon atoms in total, such as an acyl group (for example, acetyl, propionyl, butyroyl, valeryl, heptanoyl, octanoyl, decanoyl, dodecanoyl, tridecanoyl, hexadecanoyl, and octadecanoyl), an allylcarbonyl group (for example, acryl and methacryl), an arylcarbonyl group (for example, benzoyl and naphthaloyl), and a cinnamoyl group. Specific examples thereof include cellulose acetate, cellulose acetate propionate, cellulose acetate butyrate, cellulose acetate stearate, and cellulose acetate benzoate. In the case of a mixed ester, while its mixing ratio is not particularly limited, it is preferable that the acetate accounts for 30% by mole or more of the whole ester.

Of these, cellulose acylates are preferable, and those of a photographic grade are especially preferable. Commercially available cellulose acylates of a photographic grade are satisfactory with respect to qualities such as viscosity average polymerization degree and substitution degree. Examples of manufacturers of cellulose triacetate of a photographic grade include Daicel Chemical Industries, Ltd. (for example, LT-20, LT-30, LT-40, LT-50, LT-70, LT-35, LT-55, and LT-105), Eastman Kodak Company (for example, CAB-551-0.01, CAB-551-0.02, CAB-500-5, CAB-381-0.5, CAB-381-O₂, CAB-381-20, CAB-321-0.2, CAP-504-0.2, CAP-482-20, and CA-398-3), Courtaulds Chemicals, and Hoechst AG. All of cellulose acylates of a photographic grade available from these manufacturers can be used. Furthermore, for the purpose of controlling the mechanical characteristic or optical characteristics of the film, it is possible to mix a plasticizer, a surfactant, a retardation regulator, a UV absorber, or the like (see, for example, Japanese Laid-Open Patent Publication “Tokkai” Nos. 2002-277632 and 2002-182215).

In the invention, it is preferable that the transparent protective film, especially the transparent protective film to be disposed in the liquid crystal cell side is a cellulose acylate film comprising a cellulose acylate having a degree of acyl substitution of from 2.85 to 3.00 and from 0.01 to 30% by weight, based on the solids of the cellulose acylate, of a compound which contributes to a lowering of Re and Rth. Examples of the compound, which contributes to lowering Re and Rth, include N-methyl-N-phenyl-benzamide, triphenylmethanol, N-phenyl-benzenesulfonamide, cyclohexanecarboxylic acid cyclohexylmethylamide, 4-methyl-N-phenyl-benzenesulfonamide, and cyclohexanecarboxylic acid dicyclohexylamide. By adding the compound having the foregoing nature to the cellulose acylate within the foregoing range to prepare a cellulose acylate film, it is possible to prepare a film for transparent protective film having characteristics such that the in-plane Re is from about 0 to 30 nm and that the Rth is from about −30 nm to 30 nm.

As a method for molding a transparent resin into a sheet or film-like form, for example, all of a heat melt molding method and a solution casting method can be employed. In more detail, the heat melt molding can be classified into an extrusion molding method, a press molding method, an inflation molding method, an injection molding method, a blow molding method, a stretching molding method, and the like. Above all, in order to obtain a film which is excellent in mechanical strength, surface precision, etc., an extrusion molding method, an inflation molding method, and a press molding method are preferable, and an extrusion molding method is the most preferable. The molding condition is properly chosen depending upon the intended object for use and the molding method. In the case of the heat melt molding method, the cylinder temperature is properly chosen within the range of preferably from 100 to 400° C., and more preferably from 150 to 350° C. The thickness of the foregoing sheet or film is preferably from 10 to 300 μm, and more preferably from 30 to 200 μm.

Stretching of the foregoing sheet or film is carried out in at least one direction in a stretching ratio of from 1.01 to 2 times at a temperature preferably in the range of from (Tg−30° C.) to (Tg+60° C.), and more preferably in the range of from (Tg−10° C.) to (Tg+50° C.) wherein Tg represents a glass transition temperature of the subject transparent resin. The stretching direction may be at least one direction. In the case where the sheet is obtained by extrusion molding, it is preferable that the subject direction is the mechanical flow direction (extrusion direction) of the resin. As the stretching method, a free contraction uniaxial stretching method, a width-fixing uniaxial stretching method, a biaxial stretching method, and the like are preferable. Control of the optical characteristics can be carried out by controlling this stretching ratio and the heating temperature.

As a method for making the Rth of the cellulose acylate film low, it is effective to mix a compound which is thoroughly compatible with the cellulose acylate and in which a compound itself does not have a rod-like structure or a planar structure in the film. Concretely, in the case of containing a plurality of planar functional groups such as aromatic groups, a structure in which these functional groups are contained not on the same plane but on a non-plane is advantageous. Of compounds capable of lowering the optical anisotropy, a compound having an octanol-water partition coefficient (log P value) of from 0 to 7 is preferable from the viewpoint of compatibility with the cellulose acylate. A compound having a log P value exceeding 7 is poor in compatibility with the cellulose acylate and likely causes cloudiness or powdering of the film. Also, since a compound having a log P value of less than 0 has high hydrophilicity, it may possibly deteriorate resistance to water of the cellulose acylate film. The log P value is more preferably in the range of from 1 to 6, and especially preferably in the range of from 1.5 to 5. The measurement of the octanol-water partition coefficient (log P value) can be carried out according to the flask shaking method described in JIS (Japanese Industrial Standards) Z7260-107 (2000).

Furthermore, the compound capable of lowering the optical anisotropy preferably has a molecular weight of from 150 to 3,000, more preferably from 170 to 2,000, and especially preferably from 200 to 1,000. When the molecular weight of the subject compound falls within this range, the compound may have a specific monomer structure or an oligomer structure or polymer structure in which a plurality of the subject monomer units are bound to each other.

The compound capable of lowering the optical anisotropy is preferably a liquid at 25° C. or a solid having a melting point of from 25 to 250° C., and more preferably a liquid at 25° C. or a liquid having a melting point of from 25 to 200° C. Also, it is preferable that the compound capable of lowering the optical anisotropy does not vaporize in the course of dope casting and drying in the preparation of a cellulose acylate film. The amount of addition of the compound capable of lowering the optical anisotropy is preferably from 0.01 to 30% by weight, more preferably from 1 to 25% by weight, and especially preferably from 5 to 20% by weight of the cellulose acylate. The compound capable of lowering the optical anisotropy may be used singly, or two or more kinds of the compound may be mixed in an arbitrary ratio. The compound capable of lowering the optical anisotropy may be added in any stage during the preparation step of a dope or in a final stage of the preparation step of a dope.

Examples of the compound which can be suitably used include compounds described in Japanese Laid-Open Patent Publication “Tokkai” Nos. hei 11-246704, 2001-247717, and Japanese Patent Application No. 2003-379975. By making the thickness of the cellulose acylate film thin, it is also possible to make the Rth low.

For the sake of improving the adhesion between the protective film and a layer to be provided thereon (an adhesive layer, an alignment film, or a retardation layer), the film may be subjected to a surface treatment (for example, a glow discharge treatment, a corona discharge treatment, an ultraviolet (UV) treatment, and a flame treatment). An adhesive layer (undercoat layer) may be provided on a transparent support. Furthermore, in a transparent support or a longitudinal transparent support, for the purpose of imparting slipperiness in the feeding step or preventing sticking between the back surface and the front surface after winding up, it is preferred to use one prepared by coating a polymer layer in which an inorganic particle having a mean particle size of from about 10 to 100 nm is mixed in a weight ratio of solids of from 5% to 40% on one side of the support or one formed by co-casting such a polymer layer with the support.

The protective film is usually fed in a roll form. It is preferable that the protective film is continuously stuck onto a longitudinal polarizing film such that the longitudinal directions thereof coincide with each other. Here, the alignment axis (slow axis) of the protective film may be any direction. In view of operational simplicity, the alignment axis of the protective film is preferably parallel to the longitudinal direction. When the slow axis of the protective film and the absorption axis of the polarizing film are parallel to each other, it is possible to enhance the mechanical stability of the polarizing plate, for example, prevention of dimensional change or curling of the polarizing plate. When at least two axes among three films in total of a polarizing film and a pair of protective films, for example, a slow axis of one protective film and an absorption axis of a polarizing film, or slow axes of two sheets of protective films, are substantially parallel to each other, the same effect is obtained.

[Adhesive]

An adhesive between the polarizing film and the protective film is not particularly limited. Examples thereof include PVA based polymers (including modified PVAs such as those containing an acetoacetyl group, a sulfonic acid group, a carboxyl group, an oxyalkylene group, etc.) and a boron compound aqueous solution. Above all, PVA based resins are preferable. The thickness of the adhesive layer after drying is preferably from 0.01 to 10 μm, and especially preferably from 0.05 to 5 μm.

Furthermore, the invention also relates to an elliptically polarizing plate comprising a polarizing film, protective films disposed on the both surfaces of the polarizing film, and a retardation film disposed adjacent to at least one of the protective films, wherein an absorption axis of the polarizing film and a slow axis of the retardation film are disposed perpendicular or parallel to each other; the retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and the protective film adjacent to the film retardation comprises a cellulose acylate and has a retardation Rth in the thickness direction of from −30 nm to 30 nm. The polarizing film and the transparent protective film which can be utilized in the preparation of the elliptically polarizing plate of the invention are the same as described previously, and preferred ranges thereof are also the same. Also, with respect to the retardation film which can be utilized in the preparation of the elliptically polarizing plate of the invention, the preferred range of the optical characteristics of the first retardation film, the material to be used for the preparation, the preparation method, and so on as described previously are applied as they are.

Examples of the construction of the elliptically polarizing plate of the invention include a laminate structure of the transparent protective film (1a in FIG. 2), the polarizing film (2a in FIG. 2), the transparent protective film (1b in FIG. 2), and the first retardation film (3a shown in FIG. 2); and a laminate structure of the transparent protective film (1a shown in FIG. 3), the polarizing film (2a shown in FIG. 3), the transparent protective film (1b shown in FIG. 3), and the first retardation film (3a shown in FIG. 3); and a laminate structure of the transparent protective film (1a shown in FIG. 3), the polarizing film (2a shown in FIG. 3), the transparent protective film (1b shown in FIG. 3), the first retardation film (3a shown in FIG. 3), and the second retardation film (6 shown in FIG. 3).

### EXAMPLES

The invention will be further specifically described below with reference to the following Examples. Materials, reagents, amounts and proportions thereof, operations, and the like as shown in the following Examples can be properly changed so far as the gist of the invention is not deviated. Accordingly, it should not be construed that the scope of the invention is limited to the following specific examples.

<Preparation of Liquid Crystal Cell 1>

A liquid crystal cell was prepared by setting up a cell gap between substrates at 3.6 μm and injecting dropwise a liquid crystal material with negative dielectric anisotropy (MLC6608, manufactured by Merck & Co., Inc.) between the substrates, followed by sealing to form a liquid crystal layer between the substrates. The liquid crystal layer was set up so as to have a retardation (namely, the product Δn·d of a thickness d (μm) and a refractive index anisotropy Δn of the liquid crystal layer) of 300 nm. Incidentally, with respect to the liquid crystal material, an alignment film (JALS-2021-R1, manufactured by JSR Corporation) was coated on the substrates, and a liquid crystal was vertically aligned. In this way, a liquid crystal cell 1 of a VA mode was prepared.

<Preparation of a First Retardation Film 1>

A thermally shrinkable film made of a uniaxially stretched polyester film was adhered on the both surfaces of a polycarbonate film having a thickness of 80 μm and an Re of 250 nm via an acrylic adhesive layer such that its slow axis was crossing, and the laminate was heated at 160° C. while shrinking the thermally shrinkable film by using a width-direction tenter stretching unit, thereby adjusting the length in the width direction. Thereafter, the thermally shrinkable film was stripped off to obtain a first retardation film 1.

With respect to the thus prepared first retardation film 1, the light incident angle dependency of Re was measured to calculate its optical characteristics by using an automatic birefringence analyzer (KOBRA-21ADH, manufactured by Oji Scientific Instruments). As a result, Re and Rth were 270 nm and 0 nm, respetively. Thus, it could be confirmed that Nz was 0.50.

<Preparation of a Second Retardation Film 1>

The following composition was charged in a mixing tank and stirred under heating to dissolve the respective components, thereby preparing a cellulose acetate solution.

Composition of cellulose acetate solution

| | | |
|---|---|---|
| Cellulose acetate having a degree of | 100 | parts by weight |
| acetylation of 60.9%: | | |
| Triphenyl phosphate (plasticizer): | 7.8 | parts by weight |
| Biphenyldiphenyl phosphate (plasticizer): | 3.9 | parts by weight |
| Methylene chloride (first solvent): | 300 | parts by weight |
| Methanol (second solvent): | 54 | parts by weight |
| 1-Butanol (third solvent): | 11 | parts by weight |

In a separate mixing tank, 16 parts by weight of the following retardation raising agent, 80 parts by weight of methylene chloride, and 20 parts by weight of methanol were charged and stirred under heating to prepare a retardation enhancing agent solution. A solution of 11 parts by weight of this retardation enhancing agent was mixed with 487 parts by weight of the cellulose acetate solution, and the mixture was thoroughly stirred to prepare a dope.

Retardation Enhancing Agent

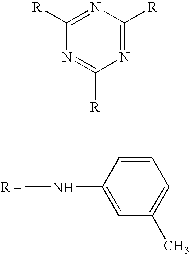

The resulting dope was cast by using a band casting machine. After the film surface temperature on the band had reached 40° C., drying with warm air at 60° C. was performed for one minute, and the film was then stripped off from the band. Next, the film was dried by dry air at 140° C. for 10 minutes to prepare a film having a thickness of 100 μm.

In addition, the film was subjected to a biaxial stretching treatment at 160° C. to obtain a retardation film having a thickness of 80 μm.

The optical characteristics of this film were determined by measuring the light incident angle dependency of Re by using an automatic birefringence analyzer (KOBRA-21ADH, manufactured by Oji Scientific Instruments). As a result, Re and Rth were 4 nm and 295 nm, respectively.

<Preparation of Second Retardation Film 2>

<<Formation of Alignment Film>>

Next, the surface of FUJITAC TD80UF (Re=2 nm, Rth=45 nm) was subjected to a saponification treatment. The saponification was carried out by dipping the foregoing film in a 2.0 N potassium hydroxide solution (25° C.) for 2 minutes, neutralizing with sulfuric acid, washing with pure water, and then drying. The surface energy of the thus saponified surface was determined by the contact method and found to be 63 mN/m. A coating liquid having the following composition was coated in an amount of 28 mL/m² on one surface of the saponification treated film by using a #16 wire bar coater.

Composition of coating liquid for alignment film

| | |
|---|---|
| Modified polyvinyl alcohol as described below: | 20 parts by weight |
| Water: | 361 parts by weight |
| Methanol: | 119 parts by weight |
| Glutaldehyde (crosslinking agent): | 0.5 parts by weight |

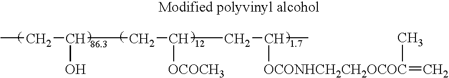

The resulting film was dried at 25° C. for 60 seconds and then dried by warm air at 60° C. for 60 seconds and additionally by warm air at 90° C. for 150 seconds. The alignment film after drying had a thickness of 1.1 μm.

<<Formation of Second Retardation Film 2 containing liquid Crystalline compound>>

A coating liquid containing a discotic liquid crystal having the following composition was coated on the thus prepared alignment film.

Composition of coating liquid for discotic liquid crystal layer

| | |
|---|---|
| Discotic liquid crystalline compound (1) *1 | 32.6% by weight |
| Compound 2 as described below | 0.15% by weight |
| Ethylene oxide-modified trimethylolpropane | 3.2% by weight |
| triacrylate (V#360, | |
| manufactured by Osaka Organic | |
| Chemical Industry Ltd.): | |
| Sensitizer (KAYACURE DETX, manufactured by | 0.4% by weight |
| Nippon Kayaku Co., Ltd.) | |
| Photopolymerization initiator (IRGACURE 907, | 1.1% by weight |
| manufactured by Ciba-Geigy AG): | |
| Methyl ethyl ketone: | 62.0% by weight |

1: As the disc-like liquid crystalline compound (1), 1,2,1′,2′,1″,2″-tris[4,5-di(vinylcarbonyloxybutoxybenzoyl-oxy)phenylene] (Illustrative Compound TE-8(8) described in paragraph [0044] of Japanese Laid-Open Patent Publication “Tokkai” No. hei 8-50206, m = 4) was used.

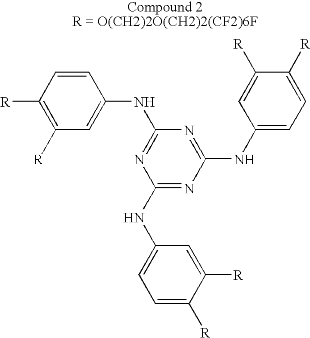

Thereafter, the resulting film was dried under heating in a drying zone at 130° C. for 2 minutes to align molecules of the discotic liquid crystalline compound. Next, molecules of the discotic liquid crystalline compound were polymerized upon irradiation of UV at 130° C. for 4 seconds by using a high pressure mercury vapor lamp of 120 W/cm, followed by allowing to stand for cooling to room temperature. There was thus formed a second retardation film 2 having a thickness of 3.4 μm and having FUJITAC TD80UF as a protective film for polarizing plate formed thereon. Next, by measuring the light incident angle dependency of Re of the prepared film by using an automatic birefringence analyzer (KOBRA-21ADH, manufactured by Oji Scientific Instruments) and subtracting a previously measured contribution part of FUJITAC therefrom, the optical characteristics of only the second retardation film 2 were calculated. As a result, it could be confirmed that Re and Rth were 0 nm and 250 nm, respectively. This discotic liquid crystalline compound was homogenously aligned within the range of ±2°.

<Preparation of Second Retardation Film 3>

A second retardation film 3 having FUJITAC TD80UF as a protective film for polarizing plate formed thereon was obtained in the same manner as in the second retardation film 2, except that the surface of FUJITAC TD80UF was not subjected to a saponification treatment and that the modified polyvinyl alcohol in the composition of the coating liquid for alignment film was replaced by commercially available polyvinyl alcohol (MP-203, manufactured by Kuraray Co., Ltd.). The measurement was carried out in the same manner. Thus, it was confirmed that Re and Rth were 0 nm and 252 nm, respectively.

<Preparation of Protective Film 1 for Polarizing Plate>

(Protective Film 1 for Polarizing Plate)

The following composition was charged in a mixing tank and stirred under heating to dissolve the respective components, thereby preparing a cellulose acetate solution A.

Composition of cellulose acetate solution A

| | | |
|---|---|---|
| Cellulose acetate having a degree of | 100 | parts by weight |
| substitution of 2.86: | | |
| Triphenyl phosphate (plasticizer): | 7.8 | parts by weight |
| Biphenyldiphenyl phosphate (plasticizer): | 3.9 | parts by weight |
| Methylene chloride (first solvent): | 300 | parts by weight |
| Methanol (second solvent): | 54 | parts by weight |
| 1-Butanol (third solvent): | 11 | parts by weight |

The following composition was charged in a separate mixing tank and stirred under heating to dissolve the respective components, thereby preparing an additive solution B-1.

<Composition of additive solution B-1>

| | |
|---|---|
| Methylene chloride: | 80 parts by weight |
| Methanol: | 20 parts by weight |
| Optical anisotropy dropping agent as described | 40 parts by weight |
| below: | |

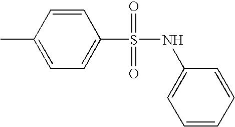

40 parts by weight of the additive solution B-1 was added to 477 parts by weight of the cellulose acetate solution A and thoroughly stirred to prepare a dope. The dope was cast on a drum as cooled at 0° C. from a casting nozzle. The film was stripped off in the state that a solvent content was 70% by weight, and the both ends in the width direction of the film were fixed by a pin tenter (a pin tenter as described in FIG. 3 of Japanese Laid-Open Patent Publication “Tokkai” No. hei 4-1009) and dried while keeping a gap such that the stretching ratio in the transversal direction (the vertical direction to the machine direction) became 3% in the state of a solvent content of from 3 to 5% by weight. Thereafter, the resulting film was further dried by delivering it between rolls of a heat treatment device, thereby preparing a protective film 1 for polarizing plate having a thickness of 40 μm.

By using an automatic birefringence analyzer (KOBRA-21ADH, manufactured by Oji Scientific Instruments), the light incident angle dependency of Re was measured to calculate its optical characteristics. As a result, it could be confirmed that Re and Rth were 1 nm and 3 nm, respectively.

<Preparation of Polarizing Plate A>

Next, iodine was adsorbed on a stretched polyvinyl alcohol film to prepare a polarizing film, and a commercially available cellulose acetate film (FUJITAC TD80UF, manufactured by Fuji Photo Film Co., Ltd., thickness: 80 μm, Re=2 nm, Rth=48 nm) was subjected to a saponification treatment and stuck onto one surface of the polarizing film using a polyvinyl alcohol based adhesive. Similarly, the protective film 1 for polarizing plate as prepared previously was stuck on the other surface of the polarizing film using a polyvinyl alcohol based adhesive. Subsequently, the first retardation film 1 prepared in the side of this protective film 1 for polarizing plate was stuck using an acrylic adhesive such that its slow axis became parallel to the transmission axis of the polarizing film, thereby forming a polarizing plate A.

<Preparation of Polarizing Plate B>

A polarizing film was prepared in the same manner, and FUJITAC TD80UF was subjected to a saponification treatment and stuck onto one surface of the polarizing film using a polyvinyl alcohol based adhesive. In addition, the second retardation film 1 as prepared previously was stuck onto the other surface of the polarizing film such that the absorption axis of the polarizing film became parallel to the MD direction of TD80UF, thereby forming a polarizing plate B.

<Preparation of Polarizing Plate C>

A polarizing film was prepared in the same manner, and FUJITAC TD80UF was subjected to a saponification treatment and stuck onto one surface of the polarizing film using a polyvinyl alcohol based adhesive. In addition, the second retardation film 2 as prepared previously was stuck onto the other surface of the polarizing film such that the absorption axis of the polarizing film became parallel to the MD direction of TD80UF and that the side of TD80UF became the side of the polarizing film, thereby forming a polarizing plate C.

<Preparation of Polarizing Plate D>

The second retardation film 3 was stuck on the side of the first retardation film 1 of the foregoing polarizing plate A using an acrylic adhesive, and TD80UF as the support was released to transfer only the second retardation film 3 containing a disc-like liquid crystalline compound onto the polarizing plate A, thereby forming a polarizing plate D.

### EXAMPLE 1

<Preparation of Liquid Crystal Display Device 1>

The polarizing plate A was stuck on one side of the liquid crystal cell 1 of a VA mode as prepared previously using an adhesive such that the absorption axis of the polarizing film became parallel to the direction of any one side of the liquid crystal cell and that the surface side of the first retardation film 1 became the side of the liquid crystal cell. Subsequently, the polarizing plate B was stuck on the other side of the liquid crystal cell 1 in the cross nicols disposition such that the surface side of the second retardation film 1 became the side of the liquid crystal cell, thereby producing a liquid crystal display device 1.

Light leakage of the thus produced liquid crystal display device was measured in a black state by turning on a backlight in the back face side of the liquid crystal display device. When viewed from a polar angle of 60° in the left oblique direction, the light leakage was extremely low as 0.02%. In addition, it was visually confirmed that when the liquid crystal display device was rotated at a polar angle of 60°, a change of the coloration in a black state was not observed.

### EXAMPLE 2

<Preparation of Liquid Crystal Display Device 2>

Next, the polarizing plate A was stuck on one side of the liquid crystal cell 1 as produced previously using an adhesive such that the absorption axis of the polarizing film became parallel to the direction of any one side of the liquid crystal cell and that the surface side of the first retardation film 1 became the side of the liquid crystal cell. Subsequently, the polarizing plate C was stuck on the other side of the liquid crystal cell 1 in the cross nicols disposition such that the surface side of the second retardation film 2 became the side of the liquid crystal cell, thereby producing a liquid crystal display device 2.

Light leakage of the thus produced liquid crystal display device was measured in a black state by turning on a backlight in the back face side of the liquid crystal display device. When viewed from a polar angle of 60° in the left oblique direction, the light leakage was extremely low as 0.02%. In addition, it was visually confirmed that when the liquid crystal display device was rotated at a polar angle of 60°, a change of the coloration in a black state was not observed.

### EXAMPLE 3

<Preparation of Liquid Crystal Display 3>

Next, the polarizing plate D was stuck on one side of the liquid crystal cell 1 as produced previously using an adhesive such that the absorption axis of the polarizing film became parallel to the direction of any one side of the liquid crystal cell and that the surface side of the second retardation film 3 became the side of the liquid crystal cell. Subsequently, a commercially available polarizing plate (HLC2-5618, manufactured by Sanritz Corporation) was stuck on the other side of the liquid crystal cell 1 in the cross nicols disposition, thereby preparing a liquid crystal display device 3.

Light leakage of the thus produced liquid crystal display device was measured in a black state by turning on a backlight in the back face side of the liquid crystal display device. When viewed from a polar angle of 60° in the left oblique direction, the light leakage was extremely low as 0.02%. In addition, it was visually confirmed that when the liquid crystal display device was rotated at a polar angle of 60°, a change of the coloration in a black state was not observed.

### EXAMPLE 4

<Preparation of Liquid Crystal Display Device 4>

Iodine was adsorbed on a stretched polyvinyl alcohol film to prepare a polarizing film. Commercially available FUJITAC TD80UF was subjected to a saponification treatment was suck onto the both surfaces of the polarizing film using a polyvinyl alcohol adhesive. Subsequently, the first retardation film 1 was stuck using an acrylic adhesive such that its slow axis became parallel to the transmission axis of the polarizing film, thereby forming a polarizing plate E. This polarizing plate E was stuck on one side of the liquid crystal cell 1 as prepared previously using an adhesive such that the absorption axis of the polarizing film became parallel to the direction of any one side of the liquid crystal cell and that the surface side of the first retardation film 1 became the side of the liquid crystal cell. Subsequently, the polarizing plate B was stuck on the other side of the liquid crystal cell 1 in the cross nicols disposition such that the surface side of the second retardation film 1 became the side of the liquid crystal cell, thereby producing a liquid crystal display device 4.

Light leakage of the thus prepared liquid crystal display device was measured in a black state by turning on a backlight in the back face side of the liquid crystal display device. When viewed from a polar angle of 60° in the left oblique direction, the light leakage was extremely low as 0.16%. That is, the liquid crystal display devices 1 to 3 in which the transparent protective film disposed between the first retardation film 1 and the polarizing film had an Rth in the range of from −30 nm to 30 nm were extremely low in the light leakage from the oblique direction and excellent as compared with the liquid crystal display device 4 in which the transparent protective film disposed between the first retardation film 1 and the polarizing film had an Rth of 48 nm.

### COMPARATIVE EXAMPLE 1

<Preparation of Liquid Crystal Display Device 5>

A commercially available polarizing plate (HLC2-5618, manufactured by Sanritz Corporation) was stuck on the both surfaces of the liquid crystal cell 1 of a VA mode as prepared previously in the cross nicols disposition such that the absorption axis of one of the polarizing films was perpendicular to the rubbing direction of the liquid crystal cell, thereby producing a liquid crystal display device 5. In addition, light leakage from a polar angle of 60° in the left oblique direction was measured. As a result, it was extremely large as 3.19%. Also, it was confirmed that the coloration was changed from blue to green depending upon the azimuth.

Having described our invention as related to the present embodiments, it is our intention that the invention not be limited by any of the details of the description, unless otherwise specified, but rather be construed broadly within its spirit and scope as set out in the accompanying claims.

What is claimed is:

1. An elliptically polarizing plate comprising:
a polarizing film,
two protective films respectively disposed on a surface of the polarizing film, and
a retardation film disposed adjacent to at least one of the protective films,
wherein an absorption axis of the polarizing film and a slow axis of the retardation film are perpendicular or parallel to each other;
the retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and
the protective film adjacent to the retardation film comprises a cellulose acylate and has a retardation Rth in the thickness direction of from −30 nm to 30 nm.

2. The elliptically polarizing plate of claim 1, wherein the protective film adjacent to the retardation film has a thickness of not more than 50 μm.

3. The elliptically polarizing plate of claim 1, wherein the protective film adjacent to the retardation film comprises a cellulose acylate having a degree of acyl substitution of from 2.85 to 3.00 and at least one compound capable of lowering the Re and Rth in an amount of from 0.01 to 30% by weight with respect to a solid weight of the cellulose acylate.

4. A liquid crystal display device comprising at least:
a first polarizing film,
a first retardation film disposed such that an absorption axis thereof and a slow axis of the first polarizing film are perpendicular or parallel to each other,
a second retardation film,
a liquid crystal cell comprising a pair of substrates and a liquid crystal layer interposed between the pair of substrates, in which liquid crystal molecules are aligned substantially vertically against surfaces of the pair of substrates in a black state, and
a second polarizing film,
wherein the first retardation film has an Nz value, as defined according to (Nz=Rth/Re+0.5) by using an in-plane retardation Re and a retardation Rth in the thickness direction, of from 0.3 to 0.7 and an in-plane retardation Re of from 150 to 400 nm; and
the second retardation film has an in-plane retardation Re of from 0 to 30 nm and a retardation Rth in the thickness direction of from 150 nm to 400 nm.

5. The liquid crystal display device of claim 4, wherein the first polarizing film, the first retardation film, the second retardation film, and the liquid crystal cell are disposed in this order.

6. The liquid crystal display device of claim 4, wherein the first polarizing film, the first retardation film, the liquid crystal cell, and the second retardation film are disposed in this order.

7. The liquid crystal display device of claim 4, wherein at least one of the first retardation film and the second retardation film is an optically anisotropic film comprising liquid crystalline molecules fixed in an alignment state.

8. The liquid crystal display device of claim 4, further comprising a pair of protective films disposed so as to interpose the first polarizing film therebetween, the protective film disposed nearer to the liquid crystal cell having a retardation Rth in the thickness direction of from −30 nm to 30 nm.

9. The liquid crystal display device of claim 4, further comprising a pair of protective films disposed so as to interpose the first polarizing film therebetween, the protective film disposed nearer to the liquid crystal cell being formed of a cellulose acylate film comprising a cellulose acylate having a degree of acyl substitution of from 2.85 to 3.00 and at least one compound capable of lowering the Re and Rth in an amount of from 0.01 to 30% by weight with respect to a solid weight of the cellulose acylate.

10. The liquid crystal display device of claim 8, wherein the protective film disposed nearer to the liquid crystal cell has a thickness of not more than 50 μm.

11. The liquid crystal display device of claim 9, wherein the protective film disposed nearer to the liquid crystal cell has a thickness of not more than 50 μm.
